(19) United States
(12) Patent Application Publication
(10) Pub. No.: US 2023/0398945 A1
(43) Pub. Date: Dec. 14, 2023

(54) CARRYING DEVICE, MOTOR VEHICLE AND CARRIER SYSTEM

(71) Applicant: AUDI AG, Ingolstadt (DE)

(72) Inventor: Sebastian VAHLE, Landshut (DE)

(73) Assignee: AUDI AG, Ingolstadt (DE)

(21) Appl. No.: 18/330,016

(22) Filed: Jun. 6, 2023

(30) Foreign Application Priority Data
Jun. 9, 2022 (DE) 10 2022 114 538.7

(51) Int. Cl. B60R 9/058

(52) U.S. Cl. CPC B60R 9/058

(57) ABSTRACT

A support apparatus having a holding structure for forming a motor vehicle/carrier coupling, wherein the holding structure has an electromagnet for generating a magnetic holding force as a safeguard against accidental or unauthorized separation of the motor vehicle/carrier coupling, wherein a control unit, which is configured in such a manner that a charge state of a battery for supplying the electromagnet with electrical power is monitored at least when the electromagnet is activated.

### TECHNICAL FIELD

The present disclosure relates to a support apparatus. Furthermore, the present disclosure relates to a motor vehicle and to a carrier system.

Particularly for passenger cars, carrier systems are available which can be fastened on the outside of a vehicle body by means of a support apparatus, and which can be used to transport loads such as luggage, bicycles, skis, etc. In particular, roof carrier systems, also called roof rack systems, which are designed for mounting on a vehicle roof, are common in this field.

### BACKGROUND

DE 10 2017 221 060 A1 discloses a carrier device for a motor vehicle according to the preamble of claim 1. On the motor vehicle, a roof rail is arranged to which individual position fastening clamps can be mechanically fixed in fastening sockets, wherein another magnetic fixation is additionally provided.

A vehicle is known from WO 2020 102449 A2, in which, on a loading surface border, several fastening receptacles are provided to which a carrier system, for example, can be fastened. Suitable latching holders which are provided in the fastening receptacles can be actuated via electromagnets.

DE 10 2021 100 346 B3 describes a load carrier arrangement for a motor vehicle, comprising two longitudinal members to which the load carriers can be fastened in an extended position of the longitudinal members, wherein the longitudinal members are movable into a retracted position for securing the load carriers.

### BRIEF DESCRIPTION OF DRAWINGS/FIGURES

FIG. 1 in a block diagram representation, a motor vehicle with a holding structure composed of two roof rails;

FIG. 2 a side view of one of the roof rails;

FIG. 3 a cross-section of one of the roof rails;

FIG. 4 a plan view of a vehicle roof of the motor vehicle with the two roof rails and with two carrier elements of a carrier system;

FIG. 5 a rear view of one of the two carrier elements; and

FIG. 6 a rear view of one of the two carrier elements together with a rooftop cargo box of the carrier system.

Parts corresponding to one another are provided with the same reference signs in all figures.

### DETAILED DESCRIPTION

It is an object of the present disclosure to specify an advantageous design of a support apparatus. It is also an object of the present disclosure to specify an advantageous design of a motor vehicle and an advantageous carrier system.

This object is achieved by a support apparatus having the features of claim 1, by a motor vehicle having the features of claim 5, by a carrier system having the features of claim 7, and by a carrier system having the features of claim 90. The advantages and preferred embodiments mentioned with respect to the support apparatus can also be transferred analogously to the other devices, i.e., the motor vehicle and the carrier systems, and vice versa. Advantageous embodiments having useful further developments of the present disclosure are specified in the dependent claims.

The support apparatus according to the present disclosure is provided for the motor vehicle sector, and has a holding structure for forming a motor vehicle/carrier coupling, i.e., a coupling between a motor vehicle—in particular, a passenger car—and a carrier or carrier system.

Depending upon the application, the support apparatus is part of a motor vehicle or part of a carrier or carrier system, i.e., for example, a so-called roof rack.

Furthermore, the holding structure has at least one electromagnet, which is preferably integrated into the holding structure. In this case, the electromagnet is expediently part of an electrical device of the support apparatus, or forms such a device. In this case, if necessary, the electromagnet serves to generate a magnetic holding force for retaining or securing the motor vehicle/carrier coupling against accidental and/or unauthorized separation. This means that the magnetic holding force is provided to prevent accidental and/or unauthorized separation of the motor vehicle/carrier coupling.

The support apparatus is preferably designed in such a way that the magnetic holding force is provided and/or usable only as a safeguard of the previously mentioned type. This means that the magnetic holding force is preferably not required in order to use the motor vehicle/carrier coupling for an application while driving. For this purpose, the support apparatus instead preferably has a design which enables a sufficiently stable and secure mechanical connection when a motor vehicle/carrier coupling is formed.

It is further expedient if the support apparatus has at least one operating element, by means of which the at least one electromagnet can be activated and/or deactivated. The corresponding operating element is then part of the electrical device of the support apparatus and, for example, is formed by a switch or pushbutton.

Further preferably, the at least one operating element is positioned such that it is protected against unauthorized access—for example, by the operating element being arranged behind a closeable flap. If the support apparatus is part of a motor vehicle, the corresponding operating element is preferably arranged in the passenger compartment of the motor vehicle, i.e., for example, in the region of a center console or on the inside on a vehicle door of the motor vehicle. According to an alternative embodiment, the corresponding operating element is positioned behind a so-called gas tank flap. If the support apparatus is part of a carrier or carrier system, e.g., a so-called roof rack, the at least one operating element is preferably positioned in an interior of a lockable box, i.e., in particular, in the interior of a so-called rooftop cargo box.

Alternatively or additionally, the support apparatus is configured in such a manner that the electromagnet, i.e., the at least one electromagnet, can be activated by radio signals of a transmitting unit. For this purpose, the electrical device of the support apparatus then has a receiving unit which is designed to receive corresponding radio signals. The transmitting unit is then typically part of an operating unit which is designed, for example, as a kind of remote control, i.e., in particular, in the manner of a garage opener, as a vehicle key, or as a smartphone, on which a specific operating app is then typically installed.

Furthermore, it is expedient for the support apparatus and in particular the electrical device to have at least one display element, i.e., for example, a light-emitting diode. The corresponding display element then expediently serves to indicate when the electromagnet is activated, i.e., is supplied with electrical power. In this case, a variant is preferred in which a corresponding display element is arranged on the holding structure or is integrated into the holding structure.

If the electromagnet, as described above, can be activated and deactivated by radio signals, the support apparatus and, in particular, the electrical device, also preferably have not only a receiving unit, but a transmitting and receiving unit. In this case, the electrical device of the support apparatus is then typically set up in such a way that, in the course of activation of the at least one electromagnet, a radio signal with which the activation is confirmed is transmitted. The electrical device of the support apparatus is then expediently configured in such a way that, in the course of deactivation of the electromagnet, a radio signal is likewise transmitted, with which the deactivation is confirmed.

In order to supply the at least one electromagnet with electrical power, the support apparatus, and in particular the electrical device of the support apparatus, typically has a battery. Alternatively, the support apparatus, and in particular the electrical device of the support apparatus, has at least one interface via which electrical power can be supplied, so that the at least one electromagnet can be fed electrical power.

Furthermore, an embodiment is preferred in which the electromagnet is designed for operation with AC voltage. In this case, the support apparatus and in particular the electrical device of the support apparatus then preferably has an inverter for converting a DC voltage into an AC voltage for the at least one electromagnet. Alternatively, the electromagnet is designed for operation with a DC voltage. In this case, the support apparatus and in particular the electrical device of the support apparatus preferably has a DC-DC converter.

If the support apparatus is part of a motor vehicle, the electrical device of the support apparatus is expediently part of an onboard electrical system of the motor vehicle. In this case, the at least one electromagnet is then supplied with electrical power via the onboard power supply system of the motor vehicle. A battery of the motor vehicle then typically serves as an energy source for the electromagnet and in particular the entire electrical device of the support apparatus. Depending upon the embodiment variant, the battery is a so-called high-voltage battery (HV battery) or a so-called low-voltage battery (LV battery). In some applications, the battery is then an additional battery which is additionally installed for supplying the at least one electromagnet with electrical power, and, in particular, the entire electrical device of the support apparatus.

According to the present disclosure, the support apparatus and in particular the electrical device of the support apparatus then has a control unit which is configured to monitor the charge state of the battery at least during operation of the at least one electromagnet, i.e., when the electromagnet is activated. If the support apparatus is part of a motor vehicle, at least the motor vehicle preferably has a control unit configured for this purpose.

In addition, the control unit is configured in such a manner that, at least when the electromagnet is activated, a measured value representative of the charge state is determined; that a threshold value, viz., a first threshold value, is predetermined or prespecified—typically, independently of the operating state of the electromagnet; and that, at least when the electromagnet is activated, a number of actions are automatically carried out if the measured value falls below the first threshold value. This is advantageous in particular if the support apparatus is part of a motor vehicle.

The aforementioned number of actions further preferably include at least one of the following actions:
sending a notification to a recipient,
reducing the electrical power supplied to the electromagnet,
deactivating the electromagnet and thus ending the supply of electrical power.

In this case, the control unit described above is expediently configured to carry out the number of actions automatically, or at least to initiate the execution thereof.

If sending a notification is provided as an action, it is typically transmitted by means of the aforementioned transmitting and receiving unit by radio signal, i.e., for example, as a message to a smartphone. If a reduction in the electrical power for the supply of the at least one electromagnet is provided, an adjustment in steps is typically realized. This means that at least two supply levels are provided which differ with respect to the voltage values and/or current intensities.

For the action of deactivating the electromagnet, a second, smaller or lower, threshold value can be prespecified according to a further embodiment, so that this action is only carried out automatically if the value drops below the second threshold value. Independently of this, this action is particularly advantageous if the battery is part of an onboard electrical system of a motor vehicle, and is not exclusively used for supplying the electromagnet and the electrical device of the support apparatus.

In an advantageous development, the first threshold value and/or the second threshold value can be predetermined via the previously mentioned operating unit, i.e., for example, via the aforementioned operating app on a smartphone, or via an onboard computer of a motor vehicle.

As already stated above, the support apparatus is part of a motor vehicle or part of a carrier or carrier system, e.g., a so-called roof rack, depending upon the application.

If the support apparatus is part of a motor vehicle, it is also preferably configured in such a way that, when the electromagnet is activated, i.e., when the supply of electrical power to the at least one electromagnet is activated, the electromagnet is automatically deactivated, i.e., the supply is automatically terminated, when a vehicle start is carried out, i.e., for example, a drive motor of the motor vehicle is started.

Furthermore, a support apparatus which is part of a motor vehicle typically has two or more electromagnets of the type described above. Depending upon the application, the control unit is then configured in such a way that the electromagnets can be activated individually, i.e., are activatable and deactivatable, and/or that the electromagnets can be activated in groups, and/or that they are all activatable together, i.e., as a unit.

In addition, a support apparatus which is part of a motor vehicle preferably has a holding structure which is arranged on a vehicle roof of the motor vehicle or which is formed by a vehicle roof of the motor vehicle. Such a holding structure further preferably has a roof rail or is formed by a number of roof rails—in particular, by two roof rails.

In this case, a number of electromagnets are then preferably integrated into at least one of the previously mentioned roof rails—in particular, two or more electromagnets. An embodiment is also advantageous in which two or more electromagnets are integrated into each roof rail.

In particular, an embodiment in which the holding structure is formed by two roof rails, viz., a first and a second roof rail, is typical in this case. In this case, two or more electromagnets are then advantageously integrated into the first roof rail. One electromagnet is preferably integrated into the region of a first, front end of the first roof rail, and, moreover, one electromagnet is preferably integrated into the region of an opposite second, rear end of the first roof rail. Alternatively or additionally, one electromagnet is integrated into a central region between the first end and the second end of the first roof rail. Depending upon the application, two or more electromagnets are also integrated into the second roof rail. One electromagnet is preferably integrated into the region of a first, front end of the second roof rail, and, moreover, one electromagnet is preferably integrated into the region of an opposite second, rear end of the second roof rail. Alternatively or additionally, one electromagnet is integrated into a central region between the first end and the second end of the first roof rail.

In addition, each roof rail that has an electromagnet is, expediently, manufactured from a material/metal with ferromagnetic properties, or has at least one insert made of a corresponding material/metal.

It is furthermore advantageous if at least one of the previously described roof rails has a cross-sectional shape which forms an undercut, either by itself or at least together with the vehicle roof of the motor vehicle. A cross-sectional shape with a base portion adjoining the vehicle roof and a head portion adjoining the base portion are useful in this case, wherein the head portion has a larger extension in the transverse direction than the base portion. The transverse direction extends transversely to a longitudinal direction in which the corresponding roof rail is elongated, and in which the motor vehicle also typically is elongated.

As already explained above, the support apparatus according to the present disclosure is part of a motor vehicle or part of a carrier or carrier system, depending upon the application. A motor vehicle according to the present disclosure has such a support apparatus according to the present disclosure. A carrier according to the present disclosure or a carrier system according to the present disclosure in turn has either a support apparatus according to the present disclosure or is designed for a support apparatus according to the present disclosure of a motor vehicle according to the present disclosure, and is accordingly compatible therewith.

If the carrier or the carrier system is designed for a previously described support apparatus according to the present disclosure, the motor vehicle/carrier coupling can be formed between the carrier or the carrier system and the support apparatus. Such a carrier and/or such a carrier system then preferably has at least one retaining bracket which can slide and/or fold.

A corresponding retaining bracket is typically part of an elongated carrier element with two opposite ends, wherein the retaining bracket is arranged at one of the ends. In addition, an embodiment of the carrier element in which such a retaining bracket is positioned at both ends is also expedient. In this case, each retaining bracket is further preferably fastened to the same base by means of a joint structure. Each joint structure is expediently designed in such a way that the associated retaining bracket can be locked in its position and in its orientation relative to the base.

The corresponding carrier element is then typically designed for an installation in such a way that, in the installed state, the carrier element spans two previously described roof rails in the transverse direction, and is mechanically fixed to the roof rails by means of the retaining brackets.

Independently of this, a variant of the previously described carriers or carrier systems is advantageous in which they have a battery and an interface for connecting the battery to the support apparatus, or at least to a motor vehicle. The corresponding battery is, for example, arranged in a so-called rooftop cargo box, or is integrated into such a cargo box, and the interface has, for example, a socket or a plug for forming a plug connection. As an alternative or in addition thereto, the interface is designed to connect to a charging device and/or to a domestic outlet, so that charging the battery is made possible as a result.

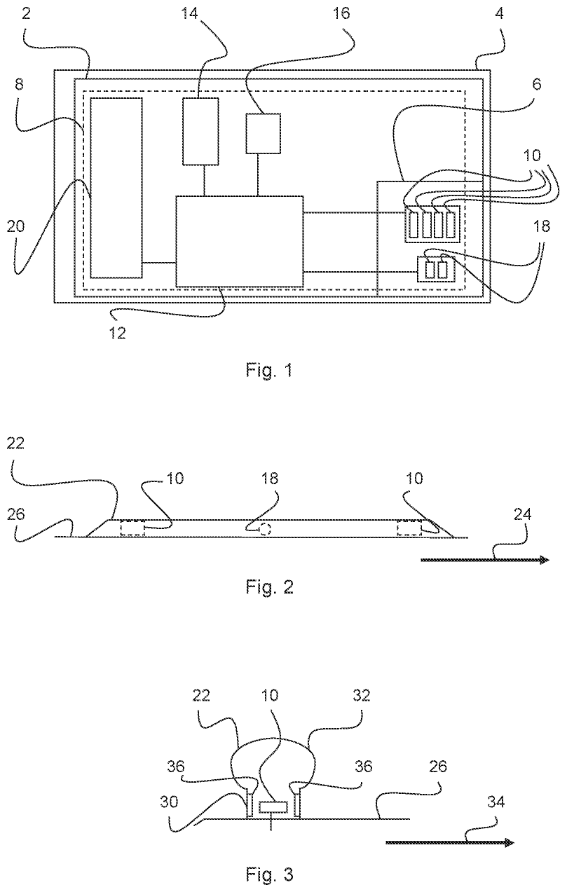

A support apparatus 2 described by way of example below is part of a motor vehicle 2 shown schematically in FIG. 1, and has a holding structure 6 for forming a motor vehicle/carrier coupling.

Furthermore, the support apparatus 2 has an electrical device 8. In this case, part of this electrical device 8 is a set of electromagnets 10, wherein each electromagnet 10 is designed to generate a magnetic holding force. Each of these magnetic holding forces serves as a safeguard against accidental and/or unauthorized separation of the motor vehicle/carrier coupling.

Furthermore, the electrical device 8 is part of an onboard network of the motor vehicle 4, and, in the exemplary embodiment, comprises a control unit 12, an operating element 14, a transmitting and receiving unit 16, two display elements 18, and a battery 20.

In the exemplary embodiment, the operating element 14 is designed as a pushbutton which is positioned behind a gas tank flap of the motor vehicle 4 in a manner not shown in detail. By actuating the pushbutton, the set of electromagnets 10 can then be activated and deactivated.

According to the exemplary embodiment, each of the display elements 18 is designed as a light-emitting diode and is positioned on the holding structure 6. Preferably, each of the light-emitting diodes is integrated into the holding structure 6.

The control unit 12 is expediently configured in such a manner that it activates the display element 18 when the set of electromagnets 10 is activated and deactivates it when the set of electromagnets 10 is deactivated.

Furthermore, the control unit 12 is preferably configured to control the transmitting and receiving unit 16 and to process radio signals received by the transmitting and receiving unit 16. The motor vehicle 4 is then additionally configured for activation and deactivation of the set of electromagnets 10 by radio signals, which are transmitted, for example, from a remote control, an automobile key, or a smartphone.

In addition, the motor vehicle 4 is preferably configured to transmit status notifications via radio signals by means of the transmitting and receiving unit 16, and, in fact, in particular every time the set of electromagnets 10 is activated or deactivated. The status notifications are in particular designed such that they can be processed by an operating app on a smartphone.

The battery 20 supplies the electrical device 8, and in particular the set of electromagnets 10, as needed.

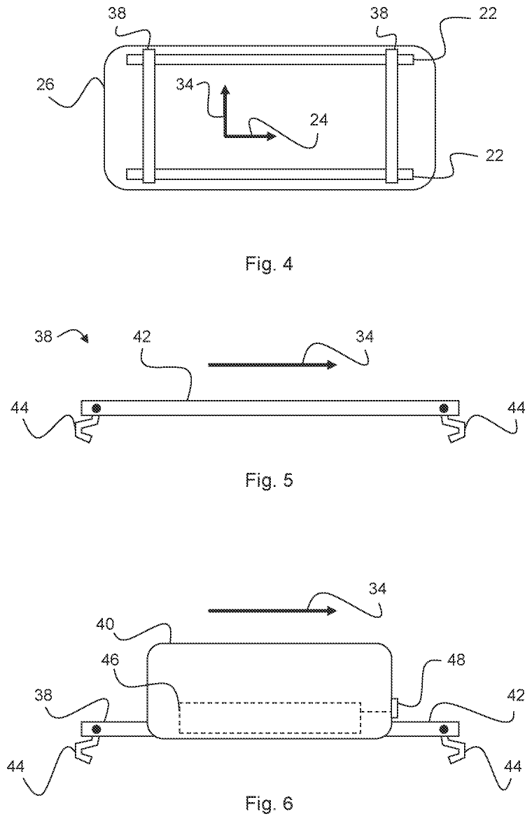

In the exemplary embodiment, the support apparatus 2 is formed by two roof rails 22 arranged in parallel, both of which extend in a longitudinal direction 24 and are arranged on a vehicle roof 26 of the motor vehicle 4. This is indicated in FIG. 4. The motor vehicle 4 also extends in this longitudinal direction 24.

FIG. 2 shows one of the two roof rails 22. In this case, dashed lines in FIG. 2 indicate that two electromagnets 10 of the set of electromagnets 10 are integrated into each of the two roof rails 22. These electromagnets 10 are arranged in each roof rail 22 such that one electromagnet 10 is positioned in the region of a front end of each roof rail 22, and one electromagnet 10 is positioned in the region of an opposite rear end.

In an alternative embodiment variant, a third electromagnet 10 is additionally integrated into each roof rail 22, which is then preferably arranged in a central region between the two ends of the respective roof rails 22. In the exemplary embodiment, however, one of the previously described display elements 18, i.e., one of the light-emitting diodes, is integrated into each roof rail 22 in the central region. These light-emitting diodes are preferably arranged so as to be recessed.

So that a carrier system 28 can be mounted on the support apparatus 2 in a simple manner, the two roof rails 22 in the exemplary embodiment each have a cross-sectional shape with a base portion 30 adjoining the vehicle roof 26 and a head portion 32 adjoining the base portion 30, wherein the head portion 32 has a greater extension in a transverse direction 34 transverse to the longitudinal direction 24 than the base portion 30. This is indicated in FIG. 3. In this case, the cross-section shows a mushroom shape.

In addition, it is indicated in FIG. 3 that each electromagnet 10 is preferably positioned in the base portion 30 and, moreover, is preferably supplemented by metal inserts 36 made of a metal with ferromagnetic properties.

A carrier system 28 suitable for the above-described support apparatus 2 and thus compatible with the support apparatus 2 is indicated in FIGS. 4 through 6. In this case, this carrier system 28 includes two carrier elements 38 which are designed for fastening to the support apparatus 2, and a rooftop cargo box 40 which is designed for fastening to the carrier elements 38.

During assembly, the two carrier elements 38 are positioned at the height of the electromagnets 10, i.e., one carrier element 38 in the region of the front ends of the roof rails 22 and one carrier element 38 in the region of the rear ends of the roof rails 22. This is shown in FIG. 4. Both carrier elements 38 are then mounted in such a way that they are elongated in the transverse direction 34, and essentially span the two roof rails 22.

Each carrier element 38 further has a base 42 with two ends opposite one another. In this case, a retaining bracket 44 is arranged at each of these ends and is connected to the base 42 via a joint structure (not shown in detail). As a result, each retaining bracket 44 is fastened to the base 42 so as to be able to slide and/or fold. This is indicated in FIG. 5. Each retaining bracket 44 also has a curved or arcuate free end, by means of which the retaining bracket 44 in the installed state encloses the head portion 32 of a roof rail 22, and thus essentially engages behind it. In addition, the retaining brackets 44 can be locked in their position, such that a mechanical connection can ultimately be formed between a carrier element 38 and the roof rails 22.

An additional battery 46 is preferably integrated into the rooftop cargo box 40, and the rooftop cargo box 40 has an interface 48 for connecting the additional battery 46 to the onboard power supply system of the motor vehicle 4. In this case, the onboard power supply system of the motor vehicle 4 is then further designed such that the additional battery 46 can be used to supply the set of electromagnets 10 with electrical power if the battery is connected via the interface 48 to the onboard electrical system of the motor vehicle 4. In the exemplary embodiment according to FIG. 6, the interface 48 is designed as a socket which can be connected to a socket of the motor vehicle 4 via a connecting cable (not shown).

1.-9. (canceled)

10. A support apparatus comprising:
a holding structure configured to form a coupling between a motor vehicle and a carrier system, wherein the holding structure comprises an electromagnet for generating a magnetic holding force as a safeguard against accidental or unauthorized separation of the coupling between the motor vehicle and the carrier system; and
a control unit configured to monitor a charge state of a battery for supplying the electromagnet with electrical power at least when the electromagnet is activated.

11. The support apparatus of claim 10, wherein the holding structure has a roof rail or is formed by two roof rails.

12. The support apparatus of claim 10, wherein the control unit is further configured to:
determine, at least when the electromagnet is activated, a measured value representative of the charge state; and
carry out a number of actions automatically when the measured value falls below a threshold value, wherein the threshold value is predetermined or pre-specified.

13. The support apparatus of claim 12, wherein the control unit is further configured to carry out the number of actions that include one or more of the following actions:
sending a notification to a recipient;
reducing the electrical power supplied to the electromagnet; or
deactivating the electromagnet.

14. A motor vehicle comprising a support apparatus, the support apparatus comprising:
a holding structure configured to form a coupling between a motor vehicle and a carrier system, wherein the holding structure comprises an electromagnet for generating a magnetic holding force as a safeguard against accidental or unauthorized separation of the coupling between the motor vehicle and the carrier system; and
a control unit configured to monitor a charge state of a battery for supplying the electromagnet with electrical power at least when the electromagnet is activated.

15. The motor vehicle of claim 14, wherein an activated electromagnet is automatically deactivated when a vehicle start is carried out.

16. The motor vehicle of claim 14, wherein the carrier system comprises a retaining bracket configured to slide and/or fold.

17. The motor vehicle of claim 16, wherein the carrier system further comprises a battery, and an interface configured for connecting the battery to the motor vehicle.

18. A carrier system, comprising:
a support apparatus, wherein the support apparatus comprises:
a holding structure configured to form a coupling between a motor vehicle and the carrier system, wherein the holding structure comprises an electromagnet for generating a magnetic holding force as a safeguard against accidental or unauthorized separation of the coupling between the motor vehicle and the carrier system; and
a control unit configured to monitor a charge state of a battery for supplying the electromagnet with electrical power at least when the electromagnet is activated.
